(19) United States
(12) Patent Application Publication
(10) Pub. No.: US 2022/0327549 A1
(43) Pub. Date: Oct. 13, 2022

(54) RETURN SERVICE METHOD

(71) Applicant: goodsFLOW co., Ltd., Seoul (KR)

(72) Inventor: Tae Jin Jung, Seoul (KR)

(73) Assignee: goodsFLOW co., Ltd.

(21) Appl. No.: 17/226,053

(22) Filed: Apr. 8, 2021

(51) Int. Cl. G06Q 30/00; G06K 19/06; G06K 19/07

(52) U.S. Cl. CPC G06Q 30/016; G06K 19/06028; G06K 19/06037; G06K 19/0723

(57) ABSTRACT

An object of the present invention is to provide a return service method for enabling quick return processing by using a waybill of a special form in which return information is included and return boxes scattered in multiple regions.

### TECHNICAL FIELD

The present invention relates to a method of returning a product delivered through a home-delivery service (return service method).

### BACKGROUND ART

Currently, as for a return service method that is used in e-commerce markets, there are a method where a purchaser directly selects a home-delivery service company for returning a product and a method where when a user manually applies to a home-delivery service company contracted with a seller for return, a courier visits the user for picking up the product and the product is thereafter transferred to the seller.

In the former method, the purchaser should directly select the home-delivery service company, which is inconvenient.

In the latter method, the purchaser who intends to return a product should wait for a courier until the courier visits, and can check whether the product picked up by the courier is safely returned and whether payment cancellation is appropriately made, after a considerable amount of time has elapsed since the purchaser returns the product.

Further, the shopping mall and the seller who sold products cannot perceive delivery information about the product being returned in real time, so that inquiries on C/S (Customer/Satisfaction) are frequently made. This increases dissatisfaction of the customers and cost for response.

### SUMMARY OF INVENTION

The present invention has been made in view of the above situations, and an object thereof is to provide a return service method by which it is possible to enable a returned product to be quickly received by using return information indicated on a waybill and to quickly return a product through a return box.

In order to achieve the above object, a return service method of the present invention includes a process where when payment for a product is made by a purchaser on a shopping mall server, a waybill server receives payment information for the product from the shopping mall server, generates waybill information and return information and provides the waybill information and the return information to a seller terminal, a waybill having a return identification tag attached thereto is output from the seller terminal, and the product on which the waybill is attached is delivered by a home-delivery service company; a process where when the return identification tag provided to the waybill is identified by any one of scanners provided to return boxes scattered in multiple regions, a return box communication unit provided to the return box transmits the return information included in the return identification tag and an inherent number and a password of the return box to a return service server; a process where the return service server transmits the return information to a home-delivery service company server managed by the home-delivery service company, the shopping mall server and the seller terminal; and a process where the shopping mall server cancels the payment upon receipt of the return information and the home-delivery service company collects the product from the return box, wherein when outputting the waybill, the return information is output to the return identification tag, and wherein the return information comprises at least one of information about a seller of a product to be returned, information about a shopping mall at which the product to be returned was sold, information about the product to be returned, information about a home-delivery service company by which the product is to be returned, information about a purchaser of the product to be returned, and return classification information by which the home-delivery service company classifies the product to be returned.

According to the present invention, since the return boxes are provided in many regions, the returned product can be received in real time and the return information for return can be provided to the home-delivery service company, the seller and the shopping mall in real time. Therefore, it is possible to secure reliability of the e-commerce, which can further invigorate and grow the e-commerce market. That is, according to the present invention, it is possible to receive a returned product in real time, and to automatically provide the return information for return to the home-delivery service company, the shopping mall and the seller.

Therefore, the purchaser can quickly enable the returned product to be received at the return box that the purchaser wants at the time the purchaser wants, and can check the return process in real time, which can increase satisfaction of the purchaser.

The home-delivery service company or the courier can visit the return box provided at a predetermined position to pick up many products, instead of visiting an unspecified number of purchasers for picking up products, so that it is possible to manage the returned products quickly and conveniently. Therefore, it is possible to efficiently pick up the returned products, which can save the cost.

The shopping mall can quickly progress refund or payment to the purchaser or the seller, so that the satisfaction of the customer (purchaser or seller) can be improved.

### BRIEF DESCRIPTION OF DRAWINGS

FIG. 1 is a view depicting an example of a configuration of a communication system to which the return service method of the present invention is applied.

FIG. 2 is a view depicting an example of a configuration of a return service server configured to provide a return service method of the present invention.

FIG. 3 is a flowchart showing an embodiment of the return service method of the present invention.

FIG. 4 exemplifies a return identification tag that is applied to the return service method of the present invention.

### DESCRIPTION OF EMBODIMENTS

Hereinbelow, the embodiments of the present invention will be described in detail with reference to the accompanying drawings.

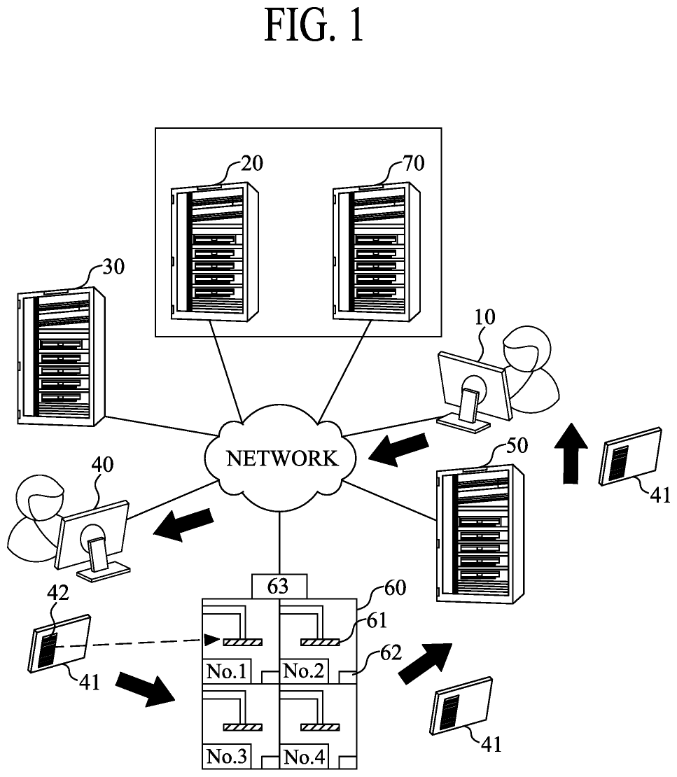

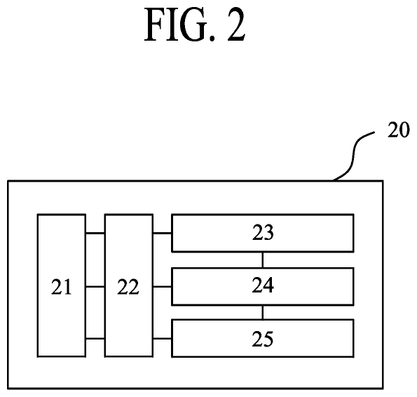

FIG. 1 is a view depicting an example of a configuration of a communication system to which the return service method of the present invention is applied, and FIG. 2 is a view depicting an example of a configuration of a return service server configured to provide a return service method of the present invention.

As shown in FIG. 1, a communication system to which the return service method of the present invention is applied includes a shopping mall server 30 configured to enable products to be traded on an online, a seller terminal 10 that is used by a seller who sells products, a purchaser terminal 40 that is used by a purchaser who purchases products, a return box 60 in which products to be returned are stored, a home-delivery service company server 50 that is managed by a home-delivery service company who delivers a product to the purchaser or returns a product from the purchaser to the seller, a waybill server 70 configured to generate a waybill including a return identification tag and to enable the same to be output from the seller terminal, and a return service server 20 that, when return information included in the return identification tag is received from a scanner provided to the return box 60, transmits the return information to the shopping mall server, the home-delivery service company server and the seller terminal.

The present invention can provide quick payment cancellation and management for returned products by providing a return service using a return box.

When purchasing a product at an online shopping mall, the subjects of the online shopping transaction are a seller who uploads products to a shopping mall, the shopping mall, a purchaser who purchases the products, and a home-delivery service company who delivers the products. In addition, when the purchasing occurs, a company who generates a waybill (hereinbelow, simply referred to as a waybill company) may also be included. The waybill server 70 and the return service server 20 may be managed by the waybill company.

The seller terminal 10 is managed by the seller, the shopping mall server 30 is managed by the shopping mall, the purchaser terminal 40 is managed by the purchaser, the home-delivery service company server 5 is managed by the home-delivery service company, the waybill server 70 is managed by the waybill company, the return box 60 is managed by the return service server 20, and the return service server 20 is managed by an administrator.

As shown in FIG. 2, the return service server 20 includes a communication unit 21 configured to perform communication with the servers and the terminals, an input unit 23 configured to receive an input of diverse information from the administrator, an output unit 24 configured to output a variety of information to the administrator, a storage unit 25 configured to store the diverse information, and a control unit 22 configured to control functions of the communication unit, the input unit, the output unit and the storage unit.

The seller terminal 10 may be a personal computer PC, and may also be a wireless terminal such as a tablet PC and a smart phone.

The purchaser terminal 40 may be a personal computer PC, and may also be a wireless terminal such as a tablet PC and a smart phone.

The waybill server 70, the shopping mall server 30 and the home-delivery service company server 50 may be network servers that are currently generally used.

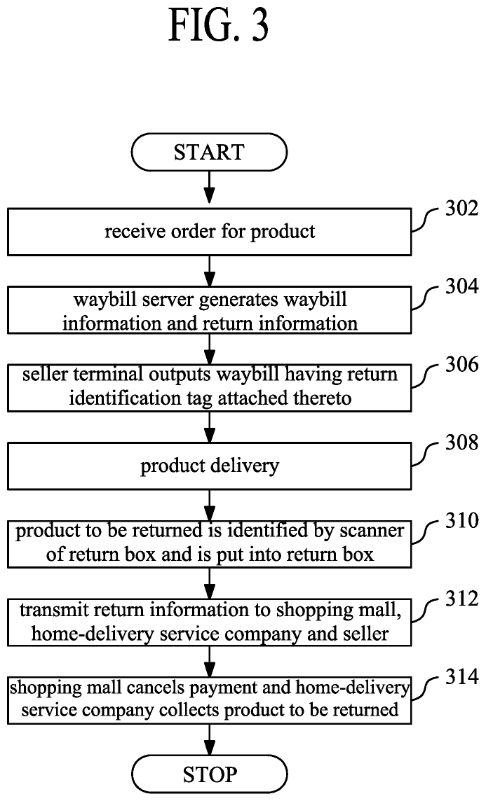

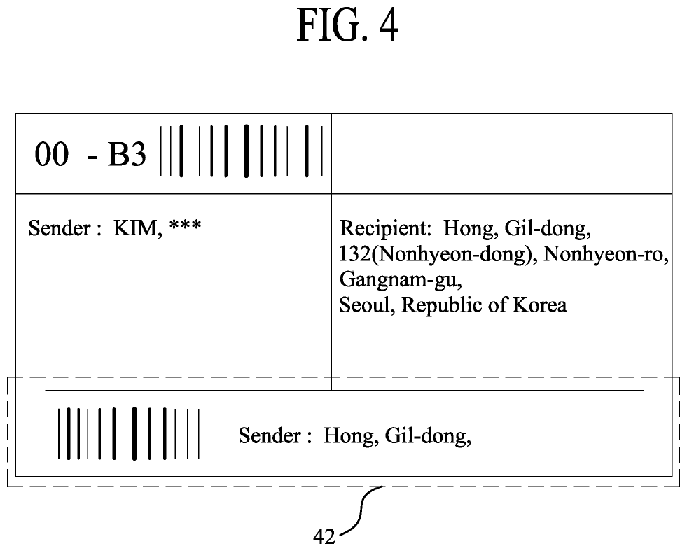

FIG. 3 is a flowchart showing an embodiment of the return service method of the present invention, and FIG. 4 exemplifies a return identification tag that is applied to the return service method of the present invention.

First, when a payment for a product is made by the purchaser on the shopping mall server 30, the shopping mall server 30 receives an order for the product (302).

Then, the waybill server 70 receives payment information for the product from the shopping mall server 30 and generates waybill information (304) and provides the waybill information to the shopping mall server 30 and the seller terminal 10. The seller terminal 10 outputs the waybill information received from the waybill company on a waybill (306), attaches the waybill to the product, and transfers the product to the home-delivery service company. The home-delivery service company delivers the product to the purchaser by using the waybill (308).

In this case, when the purchaser applies to the shopping mall for product purchasing, the waybill server 70 generates waybill information for the product and transmits the waybill information to the shopping mall server 30 and the seller terminal 10, the seller outputs the waybill information to a waybill by using the seller terminal 10, attaches the waybill to the product, and provides the product on which the waybill is attached to the home-delivery service company, and the home-delivery service company delivers the product to the purchaser. These basic processes for delivery are the same as the product delivery method that is currently generally used.

However, the present invention has a characteristic in that the waybill has a return identification tag 42. As shown in FIGS. 1 and 4, the return identification tag 42 is printed on the waybill, together with the waybill information.

The return identification tag 42 may be provide to the waybill so that it can be cut out from the waybill or can be attached and detached in a sticker form.

In this case, the user can cut or detach the return identification tag 42 from the waybill.

On the return identification tag 42, the return information relating to ‘return’ is indicated in a barcode or QR code form.

For example, the return information may include at least one of information about a seller of a product to be returned (a name, a shop name, a code, an address, a phone number and the like of the seller; hereinbelow, simply referred to as seller information), information about a shopping mall at which the product to be returned was sold (a shop name, a code, an address, a phone number and the like of the shopping mall; hereinbelow, simply referred to as shopping mall information), information about the product to be returned (a product name, a product code, a selling price and the like; hereinbelow, simply referred to as returned product information), information about a home-delivery service company by which the product is to be returned (a firm name, a code, an address, a phone number and the like of the home-delivery service company; hereinbelow, simply referred to as return home-delivery service company information), information about a purchaser of the product to be returned (a name, an address, a phone number and the like of the purchaser; hereinbelow, simply referred to as purchaser information), and return classification information by which the home-delivery service company can classify the product to be returned.

Making an additional remark, when the purchaser applies for product purchasing, the shopping mall server 30 transmits payment information for the product to the waybill server 70.

In this case, the waybill server 70 generates the waybill information by using the payment information for the product.

The waybill server 70 also generates the return information, together with the waybill information.

The waybill information including the return information is transmitted so that a waybill including a return identification tag can be output at the seller terminal 10. The return service server 20 may also be managed by an administrator of the waybill server 70 or may be managed by an administrator of a company independent of the waybill server 70.

The seller outputs the waybill information and the return information onto a waybill so that the return information is output to a return identification tag part provided to the waybill. The return information has a barcode form, a QR code form or an RFID form, and can be output to the return identification tag part 42 of the waybill. In this case, as described above, the return identification tag 42 is directly printed on the waybill so that it can be detached in a sticker form from the waybill. That is, the return identification tag can be output in a sticker form that can be separately detached from the waybill.

That is, the return identification tag can be provided in a form of attaching to or detaching from the waybill. Therefore, when intending to return a product, the purchaser can separate and use the return identification tag from the waybill. Also, when the return identification tag is provided in a sticker form separate from the waybill, the purchaser can use the return identification tag of the sticker form with carrying the same.

In descriptions below, the return identification tag may be directly printed on the waybill, the return identification tag may be provided to the waybill in a sticker form capable of detaching and the return identification tag may also be provided in an independent sticker form.

The seller attaches the waybill to the product and transfers the product to the home-delivery service company, and a courier belonging to the home-delivery service company delivers the product to an address of the purchaser written on the waybill.

After the product is delivered to the purchaser, the purchaser who intends to return the product visits a place where the return box is provided, causes the product 41 to be returned to be identified by the scanner of the return box, and puts the product 41 into the return box (310).

As for the return box, for example, a post box that is recently not utilized well may be used. That is, from a standpoint of recycling resources, the post box that is recently not utilized well may be used as the return box. Currently, since the post boxes are scattered in many regions, the efficiency of the post box as the return box can be increased.

In this case, the return box 60 is provided with a scanner 61 configured to identify the return information output to the return identification tag 42. When the return information included in the return identification tag 42 is identified by the scanner 61, the information about the product 41 to be returned, which is perceived through the return identification tag 42, i.e., the return information is transmitted to the return service server 20.

Making an additional remark, when the purchaser who receives the product and intends to return the product causes the scanner 61 provided to the return box 60 to identify the return information output on the return identification tag 42, the return information for the product can be transmitted to the return service server 20, and thereafter, the purchaser puts the product 41 into the return box 60.

For example, the waybill may be issued with the return identification tag being attached thereto. In this case, the purchaser detaches the return identification tag, like a sticker, and can cause the scanner of the return box to identify the return identification tag.

In this case, an inherent number, a password and the like of the return box 60 can be transmitted to the return service server 20, together with the product classification information.

The return information, the inherent number, the password and the like can be transmitted to the return service server 20 via a return box communication unit 63 provided to the return box 60.

Finally, the return service server 20 can transmit the return information, the inherent number, the password and the like transmitted from the return box 60 to the home-delivery service company server 50, the shopping mall server 30 and the seller terminal 10 (314). Therefore, the product 41 put in the return box 60 can be quickly delivered to the seller, and the information about the delivery can also be quickly transferred to the purchaser terminal 40, the shopping mall server 30, the seller terminal 10 and the home-delivery service company server 50.

For example, the return information about the returned product identified by the scanner 61 is transmitted to the return service server 20, and the return service server 20 can immediately transfer the return information to the shopping mall server 30, the purchaser terminal 40, the home-delivery service company server 50 and the seller terminal 10.

In this case, even before the product to be returned through the return information is transferred to the seller, the shopping mall server 30 can immediately cancel the payment of the purchaser. That is, the payment cancellation is very quickly made.

Therefore, the payment cancellation can be immediately made as the purchaser puts the product into the return box, so that it is possible to solve the inconvenience of perceiving the processes of returning the product.

The seller can also quickly know which product is to be returned by using the return information transmitted from the return service server 20, and can quickly perform a countermeasure for the return, for example.

When the return information is transmitted from the return service server 20, the home-delivery service company designates a courier who will visit the return box 60. The designated courier visits the return box 60 and inputs the password to the input unit 62 provided to the return box corresponding to the inherent number, thereby opening the return box 60. The courier can collect the product 41 in the return box 60 to return the same to the seller.

That is, according to the present invention as described above, the waybill attached to the product 41 includes the return identification tag 42, and the return box 60 is provided with the scanner 61 that can identify the return identification tag 42.

In this case, the purchaser causes the return identification tag of the waybill to be identified by the scanner and then puts the product 41 into the return box 60. The return identification tag identified by the scanner includes the information about the returned product, i.e., the return information. The return service server 20 having received the return information provides the return information to the shopping mall server 30, the purchaser terminal 40, the home-delivery service company server 50 and the seller terminal 10, so that the return-related management can be quickly performed.

An object of the present invention as described above is to solve a problem that the purchaser who intends to return a product and the courier belonging to the home-delivery service company are to confront, a problem that it is difficult for a customer to know an intermediate situation until a returned product is transferred to a seller by the courier and a problem that payment cancellation is not thus immediately performed.

That is, according to the present invention, the purchaser can return the product at any time by visiting the return box that the purchaser wants at the time that the purchaser wants, without waiting for the courier to arrive. Therefore, the purchaser can quickly enable the returned product to be received and the payment cancellation can be progressed in real time, so that satisfaction of the purchaser can be increased.

The courier can collect conveniently the product from the return box without discomfort and stress of having to directly confront the purchasers. That is, the home-delivery service company or the courier can visit the return box provided at a predetermined position to pick up many products, instead of visiting an unspecified number of purchasers for picking up products, so that it is possible to quickly manage the returned products.

The shopping mall server can quickly progress refund or payment to the purchaser or the seller, so that the satisfaction of the customer (purchaser or seller) can be improved. That is, when the return information is received from the return service server, the shopping mall server can immediately cancel the payment, and the purchaser and the seller can quickly check whether or not the cancellation.

The features of the present invention are simply summarized as follows. For example, in a case where the return box 60 is provided at a convenience store, the purchaser can simply return the product 41 simply by causing the scanner 61 provided to the return box 60 to identify the return identification tag 42 attached to the product 41, without inputting a reservation number or his/her phone number to the return box 60 equipped in the convenience store.

That is, according to the present invention, the return identification tag 42 that functions as a return waybill is provided in a form of a barcode, a QR code, an RFID or the like, and can be attached to the product 41 together with the waybill.

After the return identification tag 42 attached to the product 41 is transferred to the user, the purchaser who intends to apply for a return detaches the return identification tag 42 and causes the scanner 61 to identify the return identification tag 42.

When the return identification tag 42 is identified by the scanner 61, a door of the return box 60 can be opened, so that the purchaser can end all processes for return simply by inputting the product to be returned into the return box 60, without an additional action.

In this case, after the return identification tag 42 is identified by the scanner 61, the return box communication unit provided to the return box can transmit the return information included in the return identification tag to the return service server.

The seller terminal, the shopping mall server and the home-delivery service company server can each store the information about the returned product. However, all information about the returned product can be managed by the return service server 20 or can be transmitted to the seller terminal, the shopping mall server, the home-delivery service company server and the like through the return service server 20.

In this case, the home-delivery service company server can collect and collectively deliver the returned products to the seller by using the return classification information.

Thereby, the home-delivery service company server can effectively deliver the returned products to the seller.

That is, the home-delivery service company does not have to return the returned products one by one to the seller and can classify and effectively deliver the returned products to the seller by using the return classification information included in the return information of the return identification tag.

For example, when the purchaser causes the return identification tag to be identified by the scanner of the return box and puts the product into the return box, the information is transmitted to the shopping mall server through the return service server, so that the shopping mall server can immediately process the purchasing cancellation. In this case, the home-delivery service company does not have to deliver the returned products one by one to the seller, and can classify the returned products for each of sellers and collectively deliver the products to each seller.

In addition, the return classification information may further include classification information that is requested by the home-delivery service company on the basis of addresses of recipients, so as to facilitate classification of courier boxes. For example, the return identification tag may include information of business branches on a pickup location and a delivery location, terminal information on a delivery location, courier information (a name, a contact point and the like) who is responsible for pickup and delivery, and the like. Therefore, according to the present invention, it is possible to classify the courier box according to the environment of each home-delivery service company.

One skilled in the art relating to the present invention can understand that the present invention can be implemented in other specific forms without changing the technical spirit or essential features thereof. Therefore, the above embodiments should be construed in all respects as exemplary not restrictive. The scope of the present invention being indicated by the claims rather than by the foregoing description and all changes or modifications which come within the meaning and the range of equivalency of the claims are therefore intended to be embraced therein.

LIST OF REFERENCE SIGNS

| | |
|---|---|
| 10: seller terminal | 20: return service server |
| 30: shopping mall server | 40: purchaser terminal |
| 41: product | 42: return identification tag |

50: home-delivery service company server

| | |
|---|---|
| 60: return box | |
| 61: scanner | 62: input unit |

What is claimed is:

1. A return service method comprising:
a process where when payment for a product is made by a purchaser on a shopping mall server, a waybill server receives payment information for the product from the shopping mall server, generates waybill information and return information and provides the waybill information and the return information to a seller terminal, a waybill having a return identification tag attached thereto is output from the seller terminal, and the product on which the waybill is attached is delivered by a home-delivery service company;
a process where when the return identification tag provided to the waybill is identified by any one of scanners provided to return boxes scattered in multiple regions, a return box communication unit provided to the return box transmits the return information included in the return identification tag and an inherent number and a password of the return box to a return service server;
a process where the return service server transmits the return information to a home-delivery service company server managed by the home-delivery service company, the shopping mall server and the seller terminal; and
a process where the shopping mall server cancels the payment upon receipt of the return information and the home-delivery service company collects the product from the return box, wherein when outputting the waybill, the return information is output to the return identification tag, and wherein the return information comprises at least one of information about a seller of a product to be returned, information about a shopping mall at which the product to be returned was sold, information about the product to be returned, information about a home-delivery service company by which the product is to be returned, information about a purchaser of the product to be returned, and return classification information by which the home-delivery service company classifies the product to be returned.

2. The return service method according to claim 1, wherein the return information to be displayed on the return identification tag has a barcode form, a QR code form or an RFID form.

3. The return service method according to claim 1, wherein the return identification tag is to be cut from the waybill or is to be detached from the waybill in a sticker form.

4. The return service method according to claim 1, wherein the return classification information comprises at least one of information of business branches on a pickup location and a delivery location, terminal information on a delivery location, and information about a name and a contact point of a courier who is responsible for pickup and delivery, and the return classification information enables courier boxes to be classified according to an environment of each home-delivery service company.
